(19) United States
(12) Patent Application Publication
(10) Pub. No.: US 2026/0200211 A1
(43) Pub. Date: Jul. 16, 2026

(54) LAMINATED GLASS, METHOD FOR ITS MANUFACTURE, AND GLAZING ARRANGEMENT

(71) Applicant: Isophon Glas GmbH, Hann. Münden (DE)

(72) Inventors: Torsten BOLD, Hann. Münden (DE); Tobias BOLD, Hann. Münden (DE)

(21) Appl. No.: 19/445,985

(22) Filed: Jan. 12, 2026

(30) Foreign Application Priority Data
Jan. 12, 2025 (DE) 10 2025 000 084.7
Jan. 13, 2025 (DE) 10 2025 000 097.9

(51) Int. Cl. B32B 17/10

(52) U.S. Cl. CPC B32B 17/10036; B32B 17/10146; B32B 17/10266; B32B 17/10541; B32B 17/10568; B32B 17/1088; B32B 2307/422; B32B 2310/0843; B32B 2419/00

(57) ABSTRACT

The invention relates to laminated glass for a building facade with a first glass pane which is connected to a second glass pane by at least one laminating foil, wherein a plurality of laminae with a first light-absorbing surface and with at least one second light-reflecting surface are provided between the laminating foil and the first glass pane, wherein the light absorbing surface of the laminae facing the at least one laminating foil, and wherein the laminae are arranged at such a distance from one another that the laminated glass appears essentially transparent in the viewing direction toward the light-absorbing surface of the laminae and the at least one second glass pane in the viewing direction and appears less transparent in the viewing direction to the reflective surface of the laminae and the first glass pane in accordance with their spaced arrangement. The laminated glass is characterized in that the first glass pane has sections close to its surface on its exterior side with an altered surface or surface structure, which are arranged in a direction perpendicular to the exterior side of the at least one first glass pane in alignment with or precisely fitting the laminae . A laminated glass arrangement and a method for manufacturing a laminated glass are also described.

The invention relates to laminated glass according to the preamble of claim 1 and a laminated glass arrangement according to claim 10, and a method for manufacturing laminated glass according to the preamble of claim 12.

Laminated glasses, in particular laminated safety glasses consisting of two glass panes and a film, are increasingly being used as a facade elements because they meet high safety requirements. Facade elements have been enjoying increasing popularity for several decades. This is because many public administration buildings, museums, galleries, conference buildings, airport buildings or corporate administration buildings as well as railway station buildings, and even modern private city villas are increasingly being constructed with glass exterior facades.

In addition to measures to regulate the temperature of buildings, problems with bird strikes have become increasingly common, especially in high-rise buildings. To make the facades visible as obstacles to approaching birds or even flocks of birds, exterior glazings have been printed, labeled, or otherwise marked with patterns that are visible to animals. In order to be able to design the lighting conditions for residents or people working in such buildings sufficiently well, bird protection markings have been optimized with respect to their degree of coverage while maintaining their effectiveness. Through periodic or patterned arrangements of small marking elements, good protection conditions for approaching birds have been achieved with low degrees of coverage of up to a few percent of the exterior surfaces.

Bird protection measures have therefore already been implemented in various ways for glazings. For example, DE 10 2016 122 030 A 1 proposes a transparent pane with a first optically effective pattern in a first plane and a second optically effective pattern in a second plane, which is spaced from the first plane in thickness direction of the pane, in order to improve bird protection. The transparent pane can have an optically effective pattern with individual pattern elements, whereby individual pattern elements are spaced apart from each other in thickness direction of the pane. The spacing of individual pattern elements in thickness direction of the pane results in relative shifts of the pattern elements relative to each other, which can cause apparent dynamic effects when approaching (backdrop effect, moiré effect). In this way, in addition to the pattern effect of the individual patterns, the patterns interact in such a way that macroscopic patterns are present or arise or disappear again, respectively, which can be significantly dependent on the movement of a bird relative to the pane. As a result, the interacting patterns will be more effective than the sum of the individual effects, thus improving the bird strike protection effect. In particular, two or more optically effective patterns may be present in two or more planes of the pane, which may be designed to be coordinated with each other. The coordination can be such that backdrop effects are created and/or avoided in a desired manner, or moiré effects are produced, respectively. The aforementioned planes can be the two surfaces of a pane. However, it is also conceivable to establish individual pattern elements inside a thick pane.

To improve the bird protection function of glazings, EP 4 317 101 A further proposes a multiple glazing, which typically comprises a first glass pane with a first outward-facing surface and a second surface opposite the first surface, a second glass pane with a third surface facing the second surface, and a fourth surface opposite the third surface, and a plurality of columns in contact with the second surface and the third surface. At least one of the first, second, third, or fourth surfaces has a reflective zone provided with at least one reflective film that serves to reflect ultraviolet light. Furthermore, at least one of the first, second, third, or fourth surfaces has a transparent area that serves to transmit ultraviolet light. The plurality of columns includes at least one column with an area that coincides with the at least one reflective film when viewed in a direction perpendicular to the first surface.

Finally, EP 3 672 800 B1 discloses a laminated glass comprising a first and a second glass pane and a laminating film composite arranged between the first and second glass panes and connected to them, with a first and a second laminating film. The laminated glass is characterized in that a plurality of sequins with a first light-absorbing surface is arranged between the first and second laminating films, wherein the sequins face the light-absorbing surface of the first laminating film and are spaced apart from each other in such a way that the laminated glass appears transparent when viewed from the side of the light-absorbing surface of the sequins.

The spaces between the plurality of sequins arranged in a spaced way are thus preferably essentially optically transparent or translucent, respectively, so that the laminated glass is only largely optically transparent or, in principle, translucent, respectively between the sequins. With the light-absorbing surface of the sequins arranged appropriately to the inside of a building, visibility or transparency from the outside can be restricted. Accordingly, the laminated glass is suitable as bird protection glass.

Due to the large number of glass enclosed high-rise buildings, especially those that stand out alone against city skylines, there is another problem when darkness falls, at night and at dawn, due to the buildings being lit up all day long or illuminated. Especially during the migration periods of birds to their winter or summer regions, birds are attracted to illuminated or floodlit high-rise buildings. The birds fly purposefully toward illuminated fixed points such as corridor or office lighting or illuminated monitors behind glass facades in search of resting places or food. When flying toward the brightly lit targets, the animals cannot see the outer glazings of the building facades in front of the targets and are killed.

Consequently, the invention is based on the problem of designing glass facades that are exposed to bird strikes in such a way that even in the dark and especially when interior lighting is prevalent in the buildings, the visibility of exterior glass facades as obstacles for birds is ensured.

The problem is coming from the features of the preamble of claims 1 and 12 solved with the characteristic features of the respective claims and with a laminated glass arrangement according to claim 10.

Accordingly, the invention provides, in a first aspect, a laminated glass, in particular laminated safety glass, for a facade of a building, comprising a first glass pane connected to at least one laminating foil with at least one second glass pane, wherein a plurality of laminae (little plates) with a first light-absorbing surface and at least one second light-reflecting surface are provided between the laminating foil and the first glass pane, wherein the light-absorbing surface of the laminae or little plates faces the at least one laminating foil, and wherein the laminaelaminae are arranged spaced from one another in such a way that the laminated glass appears transparent in the direction of view toward the light absorbing surface of the laminae and the at least one second glass pane appear transparent, and in the direction of view towards the reflective surface of the laminae and the first glass pane, these are visible according to their spaced arrangement and/or appear less transparent compared to the side of the light-absorbing surface of the laminae. The laminated glass is characterized in that the first glass pane has sections close to its exterior side, preferably spaced apart sections, with an altered or processed surface or surface structure, which are arranged in a direction perpendicular to the exterior side of the first glass pane, aligned with the laminae or in register with the laminae.

In a second aspect, the invention provides for that purpose a laminated glass arrangement with a laminated glass according to the first aspect and with at least one light source attached to one of the surrounding edge sections of the laminated glass.

Finally, in a third aspect, the invention provides a method for manufacturing a laminated glass that appears transparent on one side, in particular a laminated glass according to the first aspect, for use as an exterior facade element or as an interior design element, in particular laminated safety glass, comprising the steps of
providing a laminating foil arrangement comprising a laminating foil and, provided thereon spaced apart from one another, laminae with a light-absorbing surface and a light-reflecting surface opposite thereto, wherein the laminae are fixed to the laminating foil with the light-absorbing surface,
inserting the laminating foil arrangement between a first and at least one second glass pane, and
connecting the first and at least one second glass pane and the laminating foil arrangement to form a laminated glass by hermetically sealing the glass panes along their edges.

The method is characterized by an application of spaced sections with an altered surface or surface structure in the area of the exterior side of the first glass pane facing the metallic reflective surface of the laminae.

According to the invention, laminated glasses, in particular laminated safety glasses, or laminated glass arrangements, in particular laminated safety glass arrangements, are provided at surfaces forming an exterior side of a building receiving them in an installed or used state with surface alterations or surface processings in such a way that these are aligned in a direction perpendicular to the exterior surface with or in register with the laminas, so-called sequins, with a first light-absorbing surface and a second light-reflecting surface, which are provided in amutually spaced manner between the exterior panes of the laminated glass. The surface processings or surface alterations, which are arranged being also spaced apart in accordance with the arrangement of the laminae, are provided facing the light-reflecting surface of the laminae. Light emanating from the surface processings or alterations, or coupled out from a multiple reflection pattern typical of parallel glass pane arrangements and projected onto the light-reflecting surface of the laminae, is reflected by the laminae in such a way that bright spots or areas that correspond to the arrangement pattern of the laminae and the sections of processed or altered surface or surface structure are visible from the outside. A pattern of points or areas that are brighter than the background, generated in this way, is perceptible as an obstacle by approaching birds and prevents the animals from flying into the glass exterior facades. Preferably, by appropriately selecting the arrangement and density of the laminae and the sections with a altered surface or surface structure assigned to them in the area of the outside, which serve to couple out the light rays passing through the glass when lit up, a light grid can be created that appears impenetrable to birds and thus saves their lives. The lighting can be provided by daylight, which can be supplemented by artificial lighting. During the day-night darkness, lighting is provided by one or more light sources at the edge sections of the laminated glass.

The invention has the advantage that bird protection measures can be carried out independently of the manufacturing process of laminated glass, preferably after the manufacturing process of the laminated glass. A further advantage lies in the relatively simple and inexpensive method of manufacturing a bird protection function for the laminated glass or the laminated glass arrangement. In addition, a bird protection functionality can be achieved for laminated glass that has already been installed.

The first glass pane of the laminated glass according to the invention is preferably made of white glass in order to effectively highlight the light-reflecting surface of the laminae by irradiation with light from a light source such as a light-emitting diode, so that the laminated glass is sufficiently visible by itself as an obstacle for birds even in the dark. The second glass pane is also preferably made of white glass.

In one embodiment of the laminated glass according to the invention, the sections with a altered surface or surface structure are produced by selectively sandblasting the outside of the first glass pane. This requires the outside of the first glass pane to be masked accordingly with tape or stencils. The advantage here is that the glass can be easily processed.

Alternatively, the sections with an altered surface or surface structure of the laminated glass according to the invention can be brought in by surface engraving the first glass pane using diamond-tipped grinding stones or silicon carbide grinding stones, which are set in a rotary motion using appropriate drive tools. This eliminates the need to mask the outside of the first glass pane. Phosphorescent luminescent materials can preferably be introduced in the area of the surface engraving.

In another embodiment of the laminated glass according to the invention, the sections with an altered surface or surface structure are applied by selectively etching the exterior surface of the first glass pane, for example with hydrofluoric acid. This has the advantage of achieving uniform processing of the glass.

The sections with an altered surface or surface structure can also be formed by selectively printing the outside of the first glass pane with a paint containing a phosphorescent luminescent material. This has the advantage of largely eliminating the need for artificial lighting of the laminated glass or the first glass pane and allowing natural daylight to be used to adjust the bird protection functionality according to the invention.

Applying the paint preferably takes place by a digital or screen printing process. Glass powder can also be mixed into the paint with the addition of appropriate fluxing agents or solvents.

The paint preferably contains sulfides of metals from the second main group of the periodic table of elements and/or zinc, preferably with the addition of small amounts of heavy metal salts as phosphorescent substances. This simplifies handling.

In a further embodiment of the laminated glass according to the invention, the sections with an altered surface or surface structure are formed by selective laser irradiation of the outside of the first glass pane.

In yet another embodiment of the laminated glass according to the invention, the sections with an altered surface or surface structure are produced by pointwise laser irradiation of the outside of the first glass pane. In this way, the size of the sections with an altered surface or surface structure can be specifically adjusted with a freely selectable cross-section.

Preferably, recess-like sections with an altered surface or surface structure caused by laser irradiation can be filled with phosphorescent luminescent materials and glass powder and, more preferably, baked in with the addition of a baking varnish.

In a further preferred embodiment of the laminated glass according to the invention, the sections with an altered surface or surface structure in the plane spanned by the first glass pane have a smaller extension than the sequins or laminae.

In yet another embodiment of the laminated glass arrangement according to the invention, light-emitting diodes (LEDs) are arranged or can be attached to at least one edge section in a mutually spaced manner. The bird protection functionality can thus also be achieved during darkness in a simple and cost-effective manner and can be retrofitted to installed laminated glasses.

In one embodiment of the method according to the invention, the sections with an altered surface or surface structure are produced by a selective etching process on an exterior side of the first glass pane.

In the method according to the invention, the sections with an altered surface or surface structure can also be produced by selective sandblasting of an exterior side of the first glass pane. The advantage is the subsequent processing of a laminated glass to adjust its bird protection functionality.

Alternatively, in the method according to the invention, the sections with an altered surface or surface structure of a laminated glass that appears transparent on one side can be brought in by surface engraving the first glass pane using diamond-tipped grinding stones or silicon carbide grinding stones, which can be set in rotation using appropriate drive tools. Phosphorescent luminescent materials can preferably be added in the area of the surface engraving.

In another embodiment of the method according to the invention, the sections with an altered surface or surface structure are produced by selectively applying a paint containing a phosphorescent material.

Alternatively, the method according to the invention provides for the surface treatment elements to be produced by selective laser irradiation, in particular with a CO₂ laser. The use of such lasers in glass processing offers cost advantages.

The laminae or sequins can be constructed as single or multiple layers within the scope of the present invention. The shape can be cuboid, preferably semi-concave, with the reflective surface located in the concave section. The absorption coefficient of the light-absorbing surface can be at least 50% in the visible spectral range. The light-absorbing surfaces are preferably black. The laminae or sequins used in the invention can correspond to those described in EP 3 872 800B1.

It is understood that the invention also comprises a kit consisting of a laminated glass according to claim 1 and light sources to be attached to one or more edge sections thereof.

The invention is explained in more detail below with reference to embodiments, whereby reference is made to the figures, which are kept at different scales and in some cases are greatly simplified schematically. Identical parts are designated by the same reference numerals. The figures show:

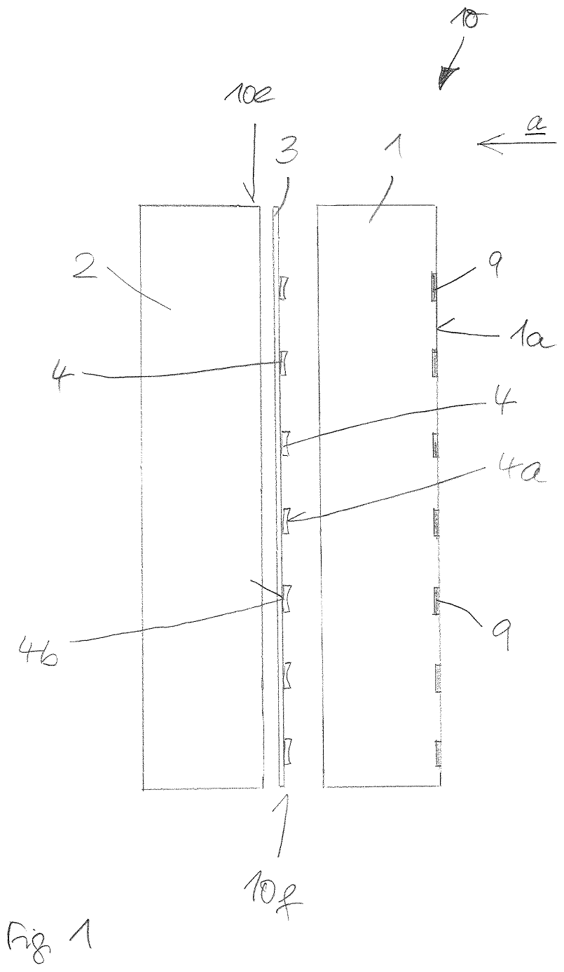

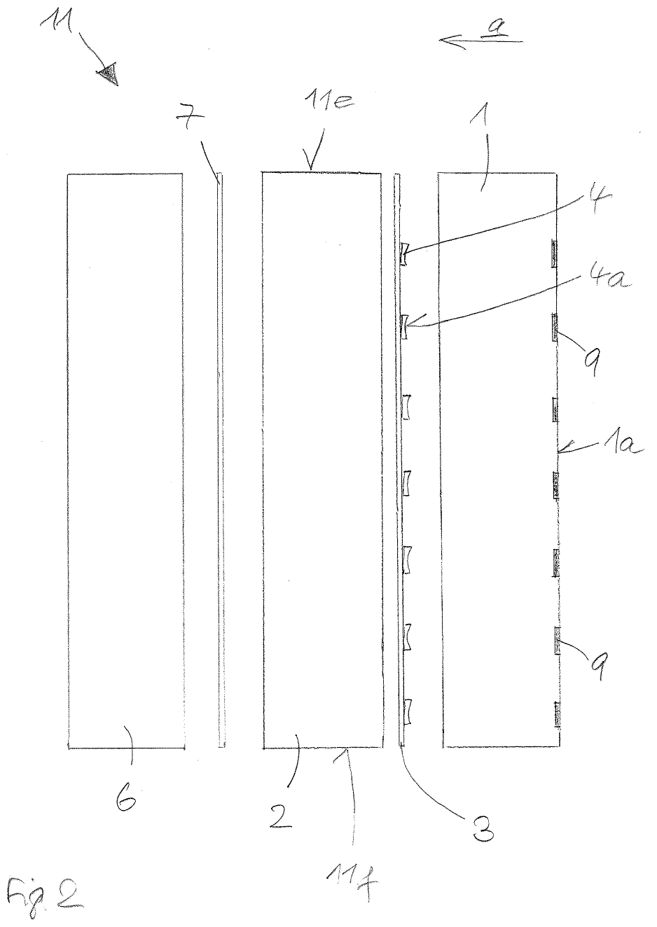

FIG. 1 a section through a first embodiment of the laminated glass according to the invention in an exploded view,

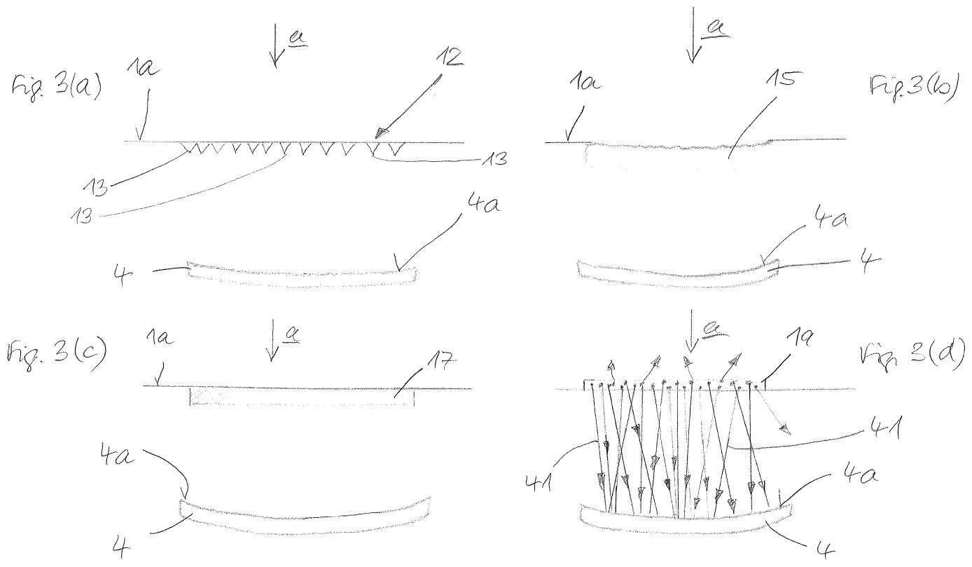

FIG. 2 a simplified representation of a second embodiment of the laminated glass according to the invention,

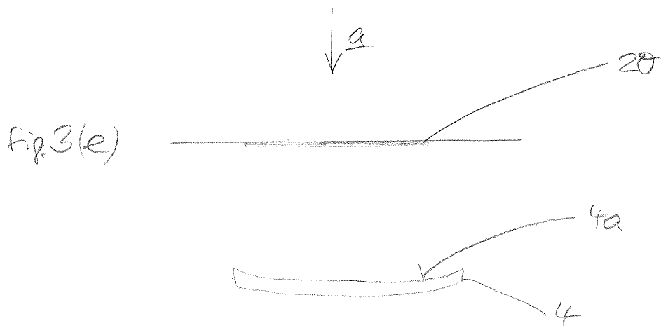

FIG. 3(a)-(e) an enlarged representation of different embodiments of surface-near sections according to the invention with an altered surface or surface structure,

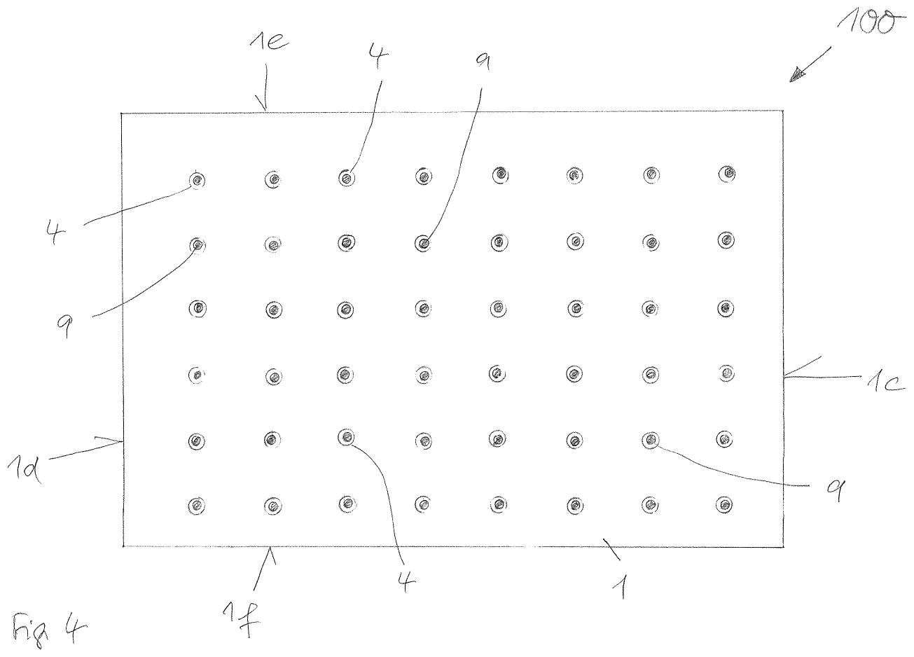

FIG. 4 a front view of a third embodiment of the laminated glass according to the invention,

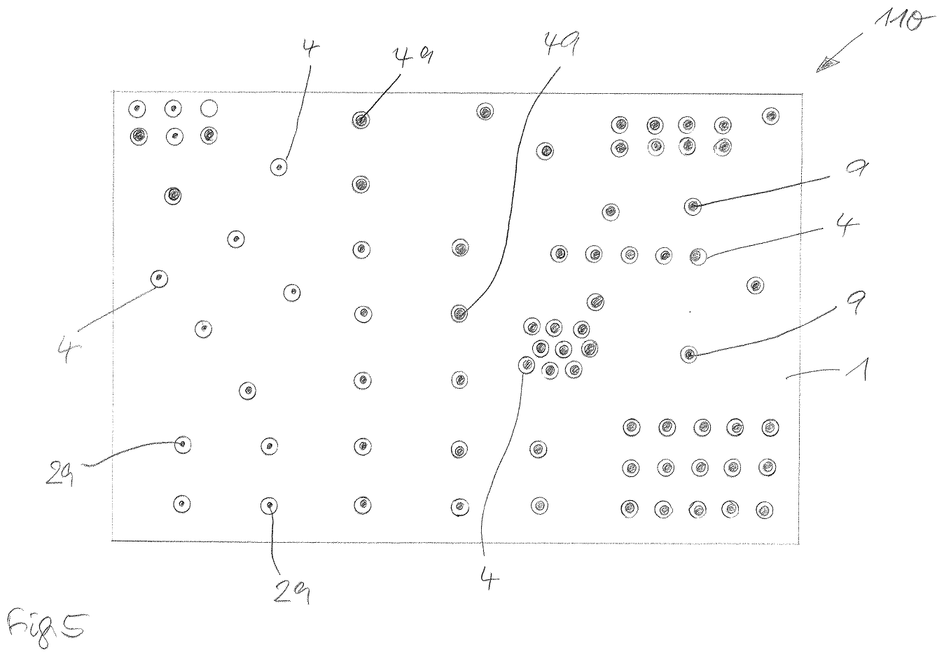

FIG. 5 a front view of a fourth embodiment of the laminated glass according to the invention,

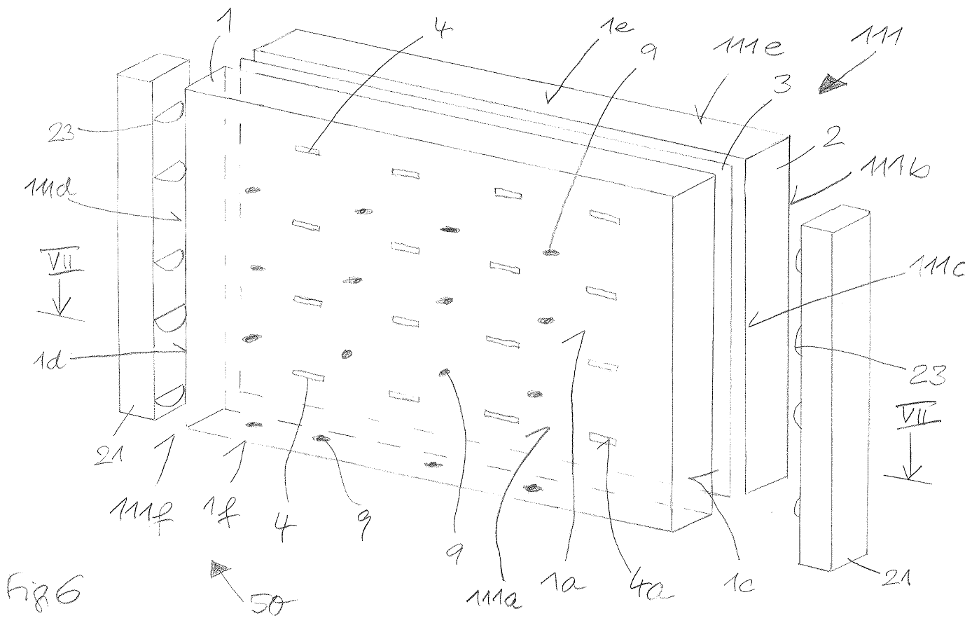

FIG. 6 a perspective view of an embodiment of a laminated glass arrangement according to the invention with a fifth embodiment of the composite glass according to the invention,

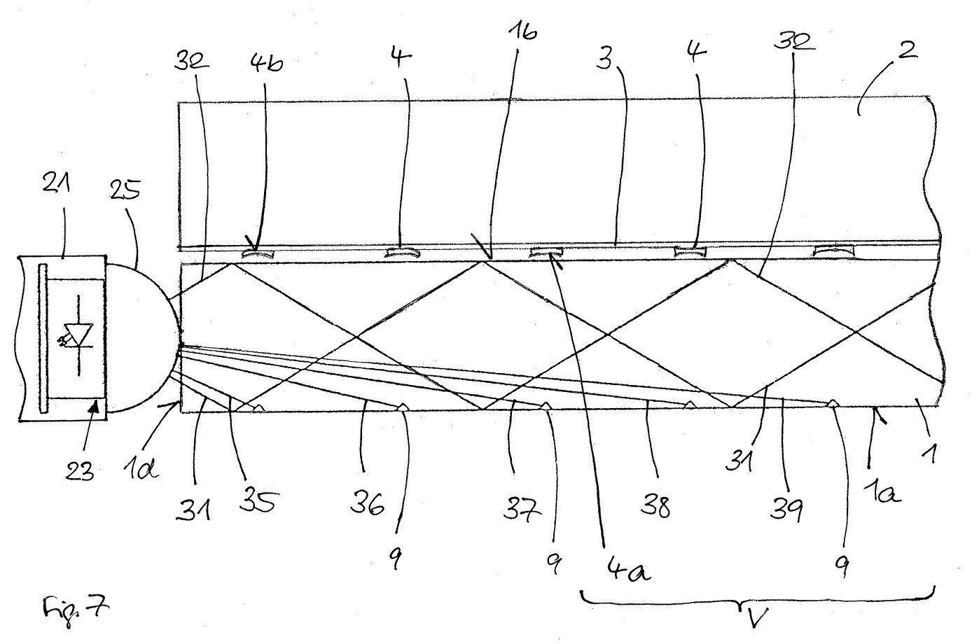

FIG. 7 a partial section along line VII-VII in FIG. 6 in an illuminated state in enlarged representation, and

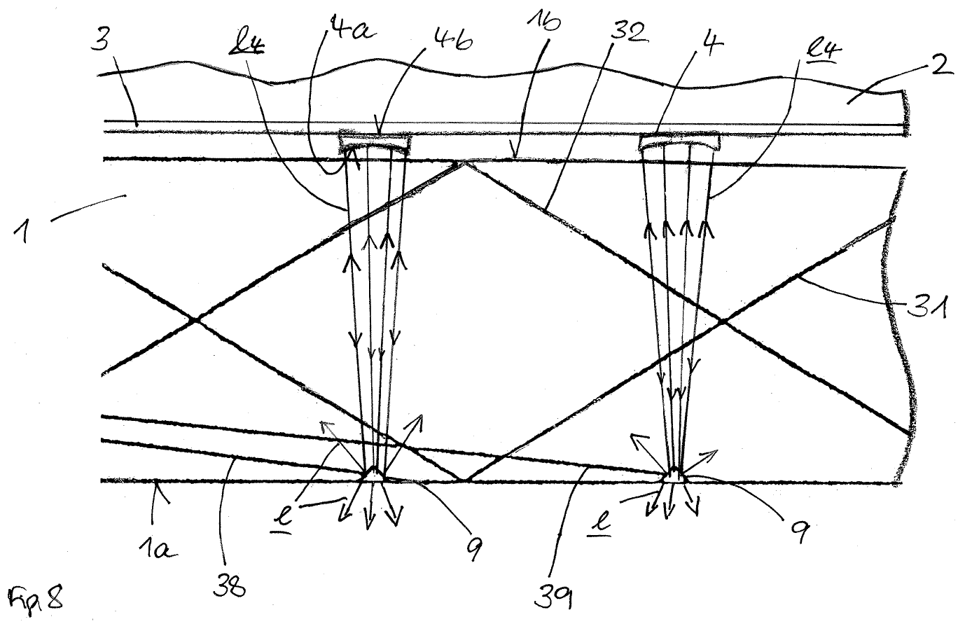

FIG. 8 the area marked with the letter V in FIG. 7 in the laminated glass according to the invention in enlarged representation.

According to FIG. 1, a first embodiment of a laminated glass according to the invention, designated overall by reference numeral 10, comprises a first glass pane 1 made of white glass, which can be connected to a second glass pane 2 arranged parallel to the first glass pane by means of a laminating foil 3 in a manner known per se to form a laminated glass 10. Laminae or little plates 4, which are preferably semi-concave in shape, are applied to the laminating foil 3, which is made of a tear-resistant and elastic material such as polyurethane, ethylene vinyl acetate, or polyvinyl butyral, for example by bonding or pressing or by another laminating process. The laminae or little plates 4 are single-or multi-layered and have a light-reflecting surface 4a and a light-absorbing surface 4b opposite to it. Depending on the shape of the laminae 4, such as a cuboid shape or a shape with a longitudinal oval cross-section, their longitudinal and transverse dimensions are between 2 and 60 mm with a thickness of 2 to 8 mm. Preferably, with a round shape, the radius is approximately 5 mm.

In a functional state, the laminating foil 3 provided with the laminae 4 is arranged between the first and second glass panes 1, 2, preferably realized as single-pane safety glass, in such a way that the reflective surface 4a of the first glass pane 1 faces the second glass pane 2, and the first glass pane 1 forms an exterior surface of a building facade or part thereof. In the case of a multi-layer structure of the laminae 4, also designated as sequins, the light-reflecting surface 4a is formed by a metallically reflective polymer film, such as a polyester film, and the light-absorbing surface 4b is formed by a light-absorbing plastic film or a dark decorative film that is perceived as black by the human eye.

Such light-absorbing elements are hidden faded out by the human eye, especially in the case of strong ambient contrast. Such elements do not stand out from their surroundings when viewed from above and are therefore hardly or not at all noticeable. Accordingly, the laminated glass 10 is basically transparent when viewed from the inside, i.e., from the second glass pane 2. This is particularly the case in darkness. Light-reflecting elements are perceived as bright or shiny when viewed from above. The elements that appear bright or shiny due to light reflection are perceived clearly and distinctly against the background image behind it by an observer looking down on the first glass pane 1. The gaze is directed or concentrated on the bright or shiny elements, making the laminated glass 10 appear more opaque from the first glass pane 1 than from the opposite side.

As shown in FIG. 2, in a further embodiment of the laminated glass 11 according to the invention, the second glass pane 2, which faces the interior of a building when the composite glass 11 is in use, can be connected to a third glass pane 6 by means of one or more laminating foils 7. The third glass pane 6 may be provided or designed for thermal insulation purposes or as another functional element, for example with regard to adjusting shading conditions or the like.

On or from an exterior side 1a extending slightly into the interior, the first glass pane 1 has sections 9 with an altered, processed or disturbed or damaged surface or surface structure. The terms sections 9 with an altered, processed, or disturbed or damaged surface or surface structure refer, in the context of the invention, to a modification of the glass structure on the exterior side 1a of the glass pane 1 or toward the exterior side 1 of the glass pane 1. The sections 9 with altered, processed, or disturbed or damaged surfaces or surface structures are spaced apart on the exterior side 1a of the first glass pane 1 in such a way that they are arranged in a direction indicated by arrow a in FIG. 1 perpendicular to the exterior side 1a of the first glass pane 1, in register or in true alignment with the laminae or sequins 4 on the laminating film 3. The sections 9 with altered, processed, or disturbed or damaged surfaces or surface structures can be produced in various ways or by various treatment processes of the glass pane 1 within the scope of the invention.

As shown in a simplified and exemplary manner in FIG. 3(a), a section with an altered, processed, disturbed, or damaged surface or surface structure 12 can be formed by a plurality of essentially funnel-shaped engraving elements, which are produced by pointwise irradiation of the first glass pane 1 from its exterior side 1a with a high-intensity laser beam, such as a beam from an infrared laser, for example a CO₂ laser. In this process, a focused laser beam melts glass material at the position of the beam, forming cone-shaped recesses 13 that recrystallize to the surface 1a. The diameter of the laser beam is approximately 3 to 4 mm, so that a section of processed or disturbed or damaged surface or surface structure 12, symbolized in FIG. 3(a), is produced by approximately fifty laser shots. The sections with altered or processed surfaces or surface structures can also be produced by means of surface engraving, as shown in simplified form in FIG. 3(e). In this process, the first glass pane 1 in section 20 is processed, roughened, or provided with small recesses using diamond-tipped grinding stones or silicon carbide grinding stones set in rotation by a drive device.

As schematically indicated in FIG. 3(b), a section with an altered, processed, or disturbed or damaged surface or surface structure 15 can be achieved by selectively etching the first glass pane 1 on its exterior side 1a, for example with hydrofluoric acid-based acids. In the etched area 15, the surface structure is altered in comparison to that of the glass on or below the remaining surface or exterior side 1a of the glass pane 1.

Another method, as shown in FIG. 3(c), is selective sandblasting of the exterior side or surface 1a, whereby a roughened section with an altered or processed surface or surface structure 17 is formed in the arrangement illustrated in FIG. 1 by masking the surface 1a. Finally, the invention also provides for printing 19 in areas and at intervals on the exterior side 1a of the first glass pane 1 with printing inks containing a fluorescent material, as shown in simplified form in FIG. 3(d).

According to FIG. 3, the laminated glass 1 according to the invention has an arrangement of the laminae 4 or sequins 4 in register with the sections 9 with an altered surface or surface structure or a true arrangement of the laminae 4 or sequins 4 and the sections 9 with an altered surface or surface structure in a direction perpendicular to the exterior surface 1a of the first glass pane 1, as illustrated by the arrow a. In a first embodiment of the composite glass 1 according to the invention, a regular arrangement of sequins 4 and sections 9 with an altered surface or surface structure 9 can be provided over the entire width of the glass pane 1 and the laminating film 3. With the arrangement shown of the surface treatment elements 9 or plates or sequins 4, respectively achieved by laser bombardment, sufficient transparency through the laminated glass 1 is provided due to a coverage of less than 15%, preferably less than 10% and more preferably less than 5% of the glass surface.

The patternings of the first glass pane 1 or the laminating film 3 of the laminated glass 100, 110 with flakes or sequins 4 and sections of modified surface or surface structure 9 can be carried out in regular or irregular arrangements—FIGS. 4, 5. As shown in FIG. 5, regular arrangements of the laminae 4 and the sections of modified surface or surface structure 9 can be mixed with irregular arrangements or patterns. Similarly, the distances between the laminae 4 and the sections of altered surface or surface structure 9, which are aligned in register or truly aligned with them in the direction of view, can be selected differently along the plane spanned by the first glass pane 1. This means that the arrangement of sections with altered surface or surface structure 9 and plates 4 can have areas of different density.

As schematically indicated in FIGS. 4 and 5 in the case of the production of sections 9 with an altered surface or surface structure, the sequins or plates 4 advantageously overlap the sections 9 with an altered surface or surface structure in the plane (paper plane) spanned by the first glass pane 1. The sections 9 with an altered surface or surface structure have a smaller extent in the plane defined by the first glass pane 1 than the sequins or laminae 4. According to the embodiment of the composite glass 110 shown in FIG. 5, the extent of the sections with an altered surface or surface structure along the plane (paper plane) defined by the glass pane 1 may differ from the extent of the plates 4 in the same plane. In addition to sections 29 with an altered surface or surface structure and a small extent, sections 9 with a larger extent, up to sections 49 whose surface extent almost corresponds to that of the plates 4, can also be attached to the exterior side 1a of the first glass pane 1.

By placing lighting ledges 21 on edge sections 111d, 111c of the laminated glass 111 according to the invention, a composite glass arrangement 50 according to the invention is realized, as shown in simplified form in FIG. 6. The lighting ledges 21 each have a row of light-emitting diodes 23 that can emit light toward edge sections 1c, 1d of the first glass pane 1. The lighting ledges 21 can be provided removably on the laminated glass 111.

As schematically illustrated in FIG. 7, lenses 25 of the light-emitting diodes 23 arranged at intervals along the edge sections 1c, 1d of the first glass pane 1 or corresponding edge sections of the laminated glass 111 are provided, so that edge rays 31 32 of the light emitted by the light-emitting diodes 23 strike the exterior sides 1a and 1b of the first glass pane 1 at the transition from the optical medium glass to an optically thinner medium—in the case of the interface 1a to the ambient air—as at the angle of total reflection α_{T} and are thus reflected accordingly from the respective interface 1a, 1b to the respective other 1b, 1a. The edge rays 31, 32 pass through the first glass pane 1 under total reflection at the two opposite interfaces 1a, 1b in order to exit the first glass pane 1 at the edge section opposite the edge section 1d serving for irradiation, provided that this is not also equipped with a lighting ledge 21.

All light beams entering the first glass pane 1 at an angle greater than the angle of total reflection α_{T} are also totally reflected, as illustrated by light beam 33, when they strike the interface between the optically denser medium glass with a refractive index n=1.5, are totally reflected and, like rays 31, 32, pass through the first glass pane 1 after several reflections from one edge section 1c to their exit at the opposite edge section 1d.

Within the scope of the invention, a lighting ledge 21 is attached to at least one edge section or both edge sections 1d, 1c of the first glass pane 1 of the laminated glass 111 or to at least one or both edge sections 111d, 111c of the laminated glass 111. It is understood that the lighting ledges 21 can be attached to two opposite edge sections 1d, 1c; 1d, 1e; 1c, 1f of the first glass pane 1 or of the laminated glass 111 or two edge sections 1d, 1c; 1d, 1e; 1c, 1f of the first glass pane 1 or of the laminated glass 111 forming an angle of 90°.

It is also understood that the light-emitting diodes 23 or the lenses 25 are positioned in such a way that the rays emitted by the light-emitting diodes 23 pass through the first glass pane 1 perpendicular to the edge sections 1a, 1b or 111a, 111b of the laminated glass 111, the light enters at the edge and emerges at the opposite edge.

FIG. 7 shows the irradiation state of the first glass pane 1. If the light emitted by the light-emitting diodes 23 into the first glass pane 1 with the aid of the lenses 25 strikes the sections 9 with an altered surface or surface structure, as illustrated by the light beams 35, 36, 37, 38, and 39, the altered structure or composition of the glass in the sections 9 with an altered surface or surface structure, in contrast to the unaltered or unprocessed areas of the first glass pane 1, causes an interruption of the reflection illustrated by the light rays 31, 32 at the edge sections 1a, 1b. Rather, the small-scale or roughened structure within the sections 9 with an altered surface or surface structure in an area close to the exterior side 1a of the first glass pane 1 causes the light 37, 38 to be “coupled out” and reflected in all directions as if coming from a light source 9, as indicated by the arrows l, l4, see FIG. 8. The altered structure in sections 9 is achieved by the processing steps described above. In the case of processing or modification of the glass structure in sections 9 by a laser irradiation process, recrystallization of the glass following irradiation contributes to a modification of the structure.

The rays l4, which originate from the sections 9 with an altered surface or surface structure and strike the plates 4 at their metallically reflective surface 4a, are reflected by the plates 4 to the opposite edge 1a and emerge from the exterior side 1a of the glass pane 1, forming points of light on the outside through the plates 4 and the sections 9 with modified surfaces or surface structures, which are arranged in register and/or in true alignment with them in perpendicular viewing direction. This allows a viewer and as intended by the invention an approaching bird to perceive the pattern of luminous points given by the sections 9 with n an altered surface or surface structure and the sequins or plates 4, and thus perceive the first glass pane 1 or the laminated glass 111, which would otherwise be invisible in the dark, as an obstacle to be flown around.

The reflection of the light rays emitted by the light-emitting diodes 23 from the reflection pattern of the sections 9 with an altered surface or surface structure is favoured by the metallic-reflective concave surface of the plates 4. This focuses the rays l4 in the direction of the opposite edge 1a or the outside 1a of the glass pane 1, respectively in a concave mirror-like manner when they are reflected from the plates 4. According to the invention, irradiating the reflective plates 4 conveys a radiant light image of them to birds approaching from outside as a warning.

In the embodiment of the sections with an altered surface or surface structure as sections 19 printed with a phosphorescent color, the light intensity irradiated by the diodes 23 can be increased. On the other hand, in this embodiment of the laminated glass according to the invention, the use of light-emitting diodes 23 can be largely dispensed with. This is because the phosphorescent dyes within the sections 19 with an altered surface or surface structure, which are irradiated by daylight, can, due to their phosphorescence properties, cause sufficient irradiation of the metal-reflecting surface 4c of the laminae or little plates 4 in the darkness of night or at dawn, thus reflecting an arrangement pattern of these laminae or little plates 4 outward as a light pattern, as symbolized in FIG. 3(d) by the arrows 41.

Phosphorescent materials can also be incorporated into the sections with an altered surface or surface structure 20 or 13 produced by engraving or laser irradiation for the purposes described in FIG. 3(d) within the scope of the invention.

Preferably suitable for this purpose are recess-like engraving elements or the cone-shaped recesses 13 of the laser irradiation, into which the phosphorescent substances are introduced. These are preferably baked in with the addition of glass powder and a baking varnish as a carrier or solvent when heated to a temperature above the transformation temperature required for the production of single-pane safety glass (ESG) and quenched to create a pre-stress in the first glass pane 1. Optionally, a so-called diffuser pigment can be added to increase light scattering in the funnel-shaped recess. Titanium oxide (TiO₂), barium sulfate, or titanium II oxide can be used as diffuser pigments within the scope of the invention.

1. Laminated glass, in particular laminated safety glass, for a facade of a building, having a first glass pane which is bonded to at least one second glass pane by means of at least one laminating foil, wherein a plurality of laminae with a first light-absorbing surface and with at least one second light-reflecting surface is provided between the laminating foil and the first glass pane, wherein the light-absorbing surface of the laminae faces the at least one laminating foil, and wherein the laminae are arranged at a distance from one another such that the laminated glass appears essentially transparent in the viewing direction toward the light-absorbing surface of the laminae and the at least one second glass pane, and appears less transparent in the viewing direction toward the reflective surface of the laminae and the first glass pane in accordance with the spaced arrangement of the plates, wherein
the first glass pane has sections close to its exterior surface with an altered surface or surface structure which are arranged in a direction perpendicular to the exterior side of the first glass pane in alignment with or in register with the laminae.

2. Laminated glass according to claim 1, wherein the sections with an altered surface or surface structure are produced by a selective sandblasting of the exterior surface of the first glass pane.

3. Laminated glass according to claim 1, wherein the sections with an altered surface or surface structure are produced by a surface engraving of the exterior side of the first glass pane.

4. Laminated glass according to claim 1, wherein the sections with an altered surface or surface structure are applied by selectively etching the first glass pane from its exterior side.

5. Laminated glass according to claim 1, wherein the sections with an altered surface or surface structure are formed by selectively printing the exterior side of the first glass pane with a paint containing a phosphorescent luminescent material.

6. Laminated glass according to claim 1, wherein the sections with an altered surface or surface structure are formed by selective laser irradiation of the exterior side of the first glass pane.

7. Laminated glass according to claim 6, wherein the sections with an altered surface or surface structure are produced by pointwise laser irradiation of the exterior side of the first glass pane.

8. Laminated glass according to claim 6, wherein recess-like regions of the sections with an altered surface or surface structure are mixed with phosphorescent luminescent materials.

9. Laminated glass according to claim 7, wherein recess-like regions of the sections with an altered surface or surface structure are mixed with phosphorescent luminescent materials.

10. Laminated glass arrangement with laminated glass according to claim 1, and with at least one light source attached to one of the surrounding edge sections of the laminated glass.

11. Laminated glass arrangement according to claim 10, wherein light-emitting diodes (LEDs) are arranged at a distance from one another on the at least one edge section.

12. Method for producing a laminated glass that one-sided appears transparent, in particular a laminated glass according to claim 1, for use as an exterior facade element, in particular laminated safety glass, comprising the steps of
providing a laminating foil arrangement out of a laminating foil and small laminae provided on this at intervals from each other with a light-absorbing surface and a light-reflecting surface opposite to the light-absorbing surface, wherein the laminae are fixed to the laminating foil with the light-absorbing surface,
inserting the laminating foil arrangement between a first and a second glass pane, and
joining the first and second glass panes and the laminating foil arrangement to form a laminated glass, with the first and second glass panes being tightly joined along their edges,
characterized by applying spaced-apart sections with an altered surface or surface structure in the region of the exterior side of the first glass pane facing the metallically reflective surface of the laminae.

13. Method according to claim 12, wherein the sections with an altered surface or surface structure are produced by a selective etching process on an exterior side of the first glass pane.

14. Method according to claim 12, wherein the sections with an altered surface or surface structure are produced by selective sandblasting of an exterior side of the first glass pane.

15. Method according to claim 12, wherein the sections with an altered surface or surface structure are produced by a surface engraving of the exterior side of the first glass pane.

16. Method according to claim 12, wherein the sections with an altered surface or surface structure are produced by selectively applying a paint containing a phosphorescent material.

17. Method according to claim 12, wherein the sections with an altered surface or surface structure are produced by selective laser irradiation, in particular with a CO₂ laser.
